(19) United States
(12) Patent Application Publication
(10) Pub. No.: US 2016/0294532 A1
(43) Pub. Date: Oct. 6, 2016

(54) Joint Radio-Frequency/Baseband Self-Interference Cancellation Methods

(71) Applicant: Huawei Technologies Canada Co., Ltd., Kanata (CA)

(72) Inventors: Ahmed Masmoudi, Montreal (CA); Tho Le-Ngoc, Montreal (CA)

(21) Appl. No.: 14/675,515

(22) Filed: Mar. 31, 2015

(51) Int. Cl. H04L 5/14; H04B 15/00; H04L 5/16

(52) U.S. Cl. CPC H04L 5/1461; H04L 5/16; H04B 15/005

(57) ABSTRACT

System and method embodiments are provided for joint radio-frequency/baseband self-interference (SI) cancellation. In an embodiment, a method for reducing self-interference (SI) in a full duplex transmission system includes estimating a radio frequency (RF) SI signal according to a sampled received signal and a transmitted signal during a half-duplex operation; obtaining a corrected signal, wherein the corrected signal is a difference signal between an analog received signal and the estimated RF SI signal, and the corrected signal comprises an intended signal plus a residual SI signal; estimating the residual SI signal in a baseband during full duplex operation; and obtaining an intended signal, wherein the intended signal is a difference signal between the corrected signal in a digital domain and the estimated residual SI signal.

### TECHNICAL FIELD

The present invention relates to a system and method for wireless communications, and, in particular embodiments, to a system and method for self-interference cancellation in wireless communication systems.

### BACKGROUND

The basic assumption in the current wireless communication systems is to transmit and receive on different time/frequency bands, i.e., in a half-duplex fashion. Full-duplex operation is a promising way to increase throughput in wireless systems and, if property deployed, will considerably increase the transmission rate. In a full-duplex operation, a wireless network element is capable of transmitting and receiving data simultaneously. However, to transmit in FD, each receiver needs to completely (or as close as possible) cancel the self-interference (SI) which is the result of its own transmit signal on the received signal bands. Therefore, in order to operate efficiently in full-duplex mode, it is desirable to develop methods and systems for self-interference cancellation or reduction.

### SUMMARY OF THE INVENTION

In accordance with an embodiment, a method for reducing self-interference (SI) in a full duplex transmission system includes estimating a radio frequency (RF) SI signal according to a sampled received signal and a transmitted signal during a half-duplex operation; obtaining a corrected signal, wherein the corrected signal is a difference signal between an analog received signal and the estimated RF SI signal, and the corrected signal comprises an intended signal plus a residual SI signal; estimating the residual SI signal in a baseband during full duplex operation; and obtaining an intended signal, wherein the intended signal is a difference signal between the corrected signal in a digital domain and the estimated residual SI signal.

In accordance with another embodiment, a wireless network component configured for full duplex operation includes a radio frequency (RF) self-interference (SI) cancellation stage component configured to estimate a RF SI signal according to a sampled received signal and a transmitted signal during a half-duplex operation, wherein the RF SI cancellation stage component is further configured to determine a corrected signal, wherein the corrected signal is a difference signal between an analog received signal and the estimated RF SI signal; and a baseband SI cancellation stage component configured to estimate the residual SI in a baseband during full duplex operation, wherein the baseband SI cancellation stage component is further configured to determine an intended signal, wherein the intended signal is a difference signal between the corrected signal in a digital domain and the estimated residual SI signal.

In accordance with another embodiment, a system for reducing self-interference in a full duplex transmission system includes a processor; and a computer readable storage medium storing programming for execution by the processor, the programming including instructions to: estimate a radio frequency (RF) self-interference (SI) according to a sampled received signal and a transmitted signal during a half-duplex operation; determine a corrected signal, wherein the corrected signal is a difference signal between an analog received signal and the estimated RF SI signal; estimate the residual SI in a baseband during full duplex operation; and determine an intended signal, wherein the intended signal is a difference signal between the corrected signal in a digital domain and the estimated residual SI signal.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a network for communications;

FIG. 2 is a block diagram of an embodiment of a system for self-interference cancellation in a full-duplex transceiver;

FIG. 3 is a flowchart illustrating an exemplary method for self-interference cancellation;

FIG. 4 is a flowchart illustrating an exemplary covariance matrix method for estimating the residual SI;

FIG. 5 is a flowchart illustrating an exemplary maximum likelihood criteria method for estimating the residual SI; and

FIG. 6 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Full-duplex transmission, by allowing simultaneous transmission/reception over the same channel, is emerging as an alternative to half-duplex communication to increase the transmission rate. The simultaneous transmission and reception creates large self-interference that needs to be properly cancelled. Recent research has shown that, using multiple cancellation stages, the self-interference can be sufficiently attenuated to detect the intended signal. Self-interference cancellation is performed before low noise amplifier (LNA) and analog-to-digital converter (ADC) to avoid overloading/saturation and further self-interference suppression can be done after ADC at the baseband. The self-interference replica is created from the known transmitted signal and an estimate of the self-interference channel, and then subtracted from the received signal. In practice, it may not be possible to completely cancel the self-interference due to channel estimation error. Therefore, channel estimation appears to be a critical issue in full duplex systems. A Least Square (LS)-based estimator is disclosed by dividing the received signal by the known transmitted signal in the frequency domain. Another approach to implement the LS criteria is iterating between channel estimation and intended signal detection. However, these two approaches treat the intended signal from the other transmitter as additive noise, which reduces the estimation performance.

In an embodiment, the deployment of full-duplex systems requires, or at least benefits from, efficient mitigation of the self-interference signal caused by the simultaneous transmission/reception. Disclosed herein is a maximum likelihood (ML) approach to jointly estimate the self-interference and the intended channels. Embodiment systems and methods exploit the known transmitted symbols from its own transceiver and both the known pilot and unknown data symbols from the other intended transceiver. In an embodiment, the ML solution is obtained by maximizing the ML function under the assumption of Gaussian received symbols. A closed-form solution is first derived, and subsequently an iterative procedure is developed to further improve the estimation performance at moderate to high signal-to-noise ratio (SNR). The initial condition is established to guarantee the convergence of the iterative procedure to the ML solution. Illustrative results show that the disclosed methods perform close to the Cramer-Rao bound (CRB) and offer good cancellation performance.

Disclosed herein is an ML channel estimation system and method in full-duplex MIMO transceivers. In an embodiment, a closed form expression is used to jointly estimate the residual self-interference and the intended channels. An iterative procedure is also disclosed to avoid the performance saturation of the closed-form solution at high SNR. The iterative procedure incorporates the statistic of the unknown received signal to improve the estimation performance.

Disclosed herein are systems and methods to jointly estimate the self-interference channel and the intended channels between the two transceivers using the maximum-likelihood (ML) criteria. The disclosed systems and methods can be applied to multipath MIMO channels with large coherence time compared to the symbol period. While the self-interference channel can be estimated from the known transmitted symbols at the same transmitter, in an embodiment, some pilot symbols are needed to estimate the intended channel. Since the received signal contains a mix of known and unknown signals, the estimation process exploits these known data and the second-order statistics of the unknown data from the intended transceiver towards the identification of the channels. The full use of the received signal reduces the number of pilot symbols needed compared to training based techniques. The unknown signal is approximated by a Gaussian process to formulate the likelihood function. In an embodiment, using some approximations, a closed-form solution to maximize the likelihood function is provided. In an embodiment, to further improve the estimation performance at high SNR, an iterative procedure which iteratively estimate the second-order statistic of the unknown signal to better estimate the channels coefficients and thereby improve the accuracy of the residual SI channel.

In an embodiment, active SI cancellation is performed in two stages: in the Radio-Frequency (RF) and in the baseband. The SI channel is estimated at each level to reduce the SI from the received signal. The RF cancellation stage is initialized using the estimated channel during the half-duplex period. A compressed-sensing-based procedure is applied to estimate the SI channel. This estimate is fed back to the RF cancellation stage to create a cancelling signal when switching to full-duplex mode. During the full-duplex period, the output of the RF cancellation stage is composed of the residual SI and the intended signal. In an embodiment, further processing is done in the baseband to reduce the residual SI. A joint estimation of the residual SI and the intended channels can be performed using, for example, either a subspace based estimator when the intended data are unknown or a maximum likelihood estimator when some intended pilots are available.

Disclosed herein is an embodiment of a method for reducing self-interference (SI) in a full duplex transmission system. The method includes estimating a radio frequency (RF) SI signal according to a sampled received signal and a transmitted signal during a half-duplex operation; obtaining a corrected signal, wherein the corrected signal is a difference signal between an analog received signal and the estimated RF SI signal, and the corrected signal includes an intended signal plus a residual SI signal; estimating the residual SI signal in a baseband during full duplex operation; and obtaining an intended signal, wherein the intended signal is a difference signal between the corrected signal in a digital domain and the estimated residual SI signal. In an embodiment, estimating the RF SI signal includes executing a compressed-sensing-based procedure. In an embodiment, estimating the residual SI includes jointly estimating the residual SI and intended signal. In an embodiment, estimating the residual SI includes maximizing a log-likelihood function. In an embodiment, the method may also include iteratively improving an accuracy of the estimated residual SI. In an embodiment, estimating the RF SI signal includes executing a compressed-sensing-based procedure. In an embodiment, at least one pilot symbol is used to estimate an intended channel and the sampled received signal contains a mix of known and unknown signals.

Disclosed herein is an embodiment of a wireless network component configured for full duplex operation. The wireless network component includes a radio frequency (RF) self-interference (SI) cancellation stage component configured to estimate a RF SI signal according to a sampled received signal and a transmitted signal during a half-duplex operation, wherein the RF SI cancellation stage component is further configured to determine a corrected signal, wherein the corrected signal is a difference signal between an analog received signal and the estimated RF SI signal; and a baseband SI cancellation stage component configured to estimate the residual SI in a baseband during full duplex operation, wherein the baseband SI cancellation stage component is further configured to determine an intended signal, wherein the intended signal is a difference signal between the corrected signal in a digital domain and the estimated residual SI signal. In an embodiment, the RF SI cancellation stage component is further configured to execute a compressed-sensing-based procedure. In an embodiment, the baseband SI cancellation stage component is further configured to jointly estimate the residual SI and intended signal. In an embodiment, the baseband SI cancellation stage component is further configured to maximize a log-likelihood function. In an embodiment, the baseband SI cancellation stage component is further configured to iteratively improve an accuracy of the estimated residual SI. In an embodiment, at least one pilot symbol is used to estimate the residual SI signal, wherein the sampled received signal contains a mix of known and unknown signals.

Disclosed herein is an embodiment of a system for reducing self-interference in a full duplex transmission system. The system includes a processor; and a computer readable storage medium storing programming for execution by the processor, the programming including instructions to: estimate a radio frequency (RF) self-interference (SI) according to a sampled received signal and a transmitted signal during a half-duplex operation; determine a corrected signal, wherein the corrected signal is a difference signal between an analog received signal and the estimated RF SI signal; estimate the residual SI in a baseband during full duplex operation; and determine an intended signal, wherein the intended signal is a difference signal between the corrected signal in a digital domain and the estimated residual SI signal. In an embodiment, the programming further includes instructions to execute a compressed-sensing-based procedure. In an embodiment, the programming further includes instructions to jointly estimate the residual SI and intended signal. In an embodiment, the programming further includes instructions to maximize a log-likelihood function. In an embodiment, the programming further includes instructions to iteratively improve an accuracy of the estimated residual SI.

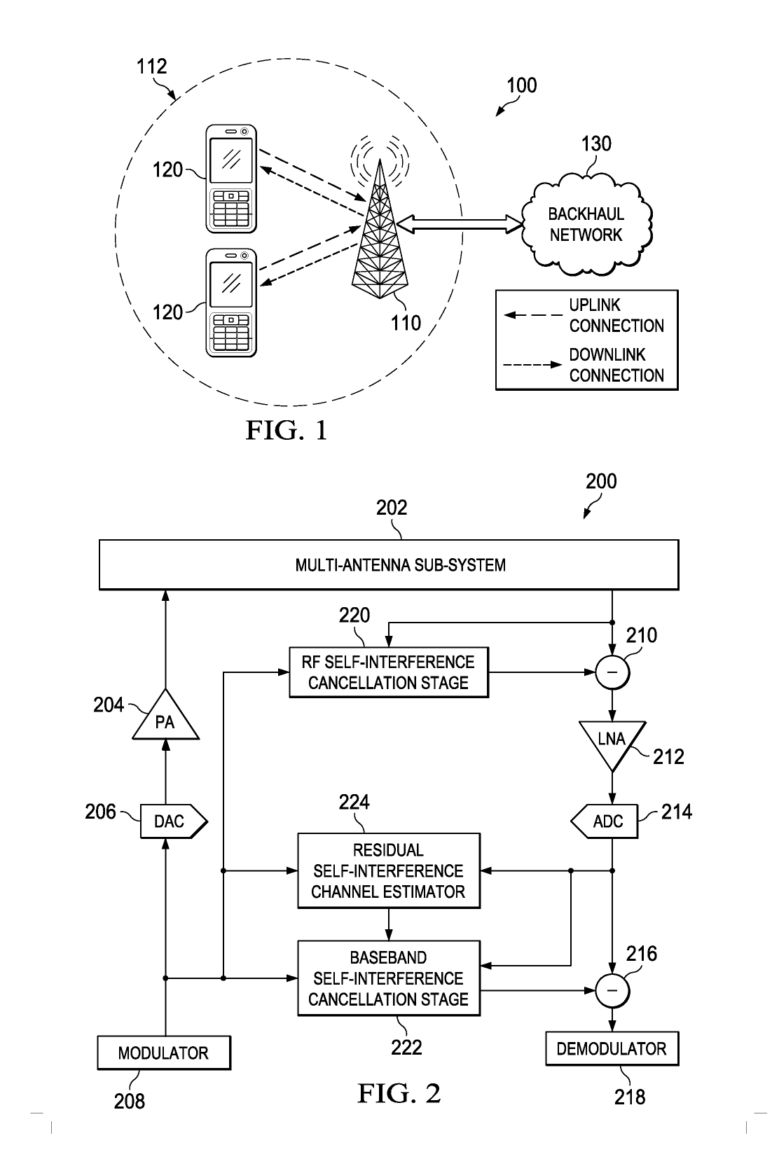

FIG. 1 illustrates a network 100 for communications. The network 100 comprises an access point (AP) 110 having a coverage area 112, a plurality of user equipment (UEs) 120, and a backhaul network 130. As used herein, the term AP may also be referred to as a TP and the two terms may be used interchangeably throughout this disclosure. The AP 110 may comprise any component capable of providing wireless access by, inter alia, establishing uplink (dashed line) and/or downlink (dotted line) connections with the UEs 120, such as a base transceiver station (BTS), an enhanced base station (eNB), a femtocell, and other wirelessly enabled devices. The UEs 120 may comprise any component capable of establishing a wireless connection with the AP 110. The backhaul network 130 may be any component or collection of components that allow data to be exchanged between the AP 110 and a remote end (not shown). In some embodiments, the network 100 may comprise various other wireless devices, such as relays, femtocells, etc.

In an embodiment, the AP 110 and UEs 120 are configured to operate in FD mode. In order to provide high isolation of transmitter power from on frequency co-located receivers in the AP 110, the AP 110 includes a self-interference cancellation systems and methods described in more detail below. In an embodiment, the AP 110 is a cellular AP. In another embodiment, the AP 110 is a WiFi AP.

FIG. 2 is a block diagram of an embodiment of a system 200 for self-interference cancellation in a full-duplex transceiver. The system 200 includes a multi-antenna sub-system 202, a modulator 208, a plurality of digital-to-analog converters (DACs) 206, a plurality of power amplifiers (PAs) 204, a subtractor 210, a plurality of low-noise amplifiers (LNAs) 212, a plurality of analog-to-digital-converters (ADCs) 214, a subtractor 216, a demodulator 218, an RF self-interference cancellation stage component 220, a baseband self-interference cancellation stage component 222, and a baseband residual self-interference channel estimator component 224. The components of system 200 may be arranged and connected substantially as shown in FIG. 2.

The modulator 208 modulates a signal and provides the modulated signal to the DACs 206, the baseband self-interference cancellation stage component 222, and the RF self-interference cancellation stage component 220. The DACs 206 convert the digital signal to an analog signal and provides it to the PA 204 for amplification before it is provided to the multi-antenna sub-system 202 for transmission.

In an embodiment, system 200 is a MIMO transceiver with Nₜ transmit streams and Nᵣ receive streams. In an embodiment, the propagation channels are frequency selective. Active SI cancellation is performed in two stages: in the RF and in the baseband. The SI channel is estimated at each level to reduce the SI from the received signal. The RF cancellation stage is initialized using the estimated channel during a half-duplex period by the RF self-interference cancellation stage component 220. In an embodiment, a compressed-sensing-based procedure is applied by RF self-interference cancellation stage component 220 to estimate the SI channel. This estimate is fed back by the RF self-interference cancellation stage component 220 to the RF subtractor 210 to create a cancelling signal when switching to full-duplex (FD) mode. The cancelling signal is subtracted from the signal received from the multi-antenna sub-system 202 by the subtractor 210 and the output from the subtractor 210 is provided to the LNAs 212.

During the FD period, the output of the RF cancellation stage is composed of the residual SI and the intended signal. The residual SI is the remaining part of the SI not accounted for and removed by the RF self-interference cancellation stage component 220. The output from the subtractor 210 is amplified by one of the LNAs 212 and converted into a digital signal by the ADC 214. Further processing on the digital residual SI and the digital intended signal is done in the baseband to reduce the residual SI. The baseband residual self-interference channel estimator component 224 jointly estimates the residual SI and the intended-signal channels and passes the residual SI channel estimate to the baseband SI cancellation stage 222 to estimate the residual SI. The baseband SI cancellation stage 222 then provides the estimated residual SI to the subtractor 216 which subtracts the residual SI from the signal. The output of the subtractor 216 is provided to the demodulator 218.

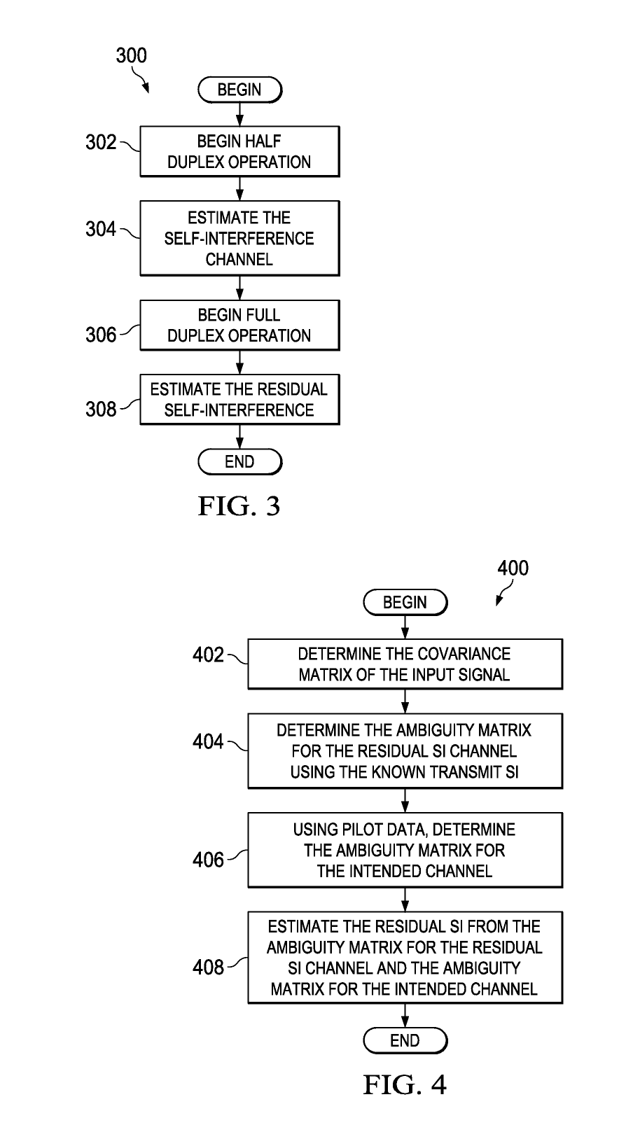

FIG. 3 is a flowchart illustrating an exemplary method 300 for self-interference cancellation. The method 300 begins at block 302 where a transceiver begins half duplex operation (i.e., a training period). At block 304, the transceiver receives only its own signal and estimates the self-interference channel 304. Since the SI data are known, a direct estimation of the SI channel can be performed using linear methods. However, linear methods do not exploit the particular structure of the channel. The SI channel actually exhibits a sparse structure. Therefore, in an embodiment, a compressed-sensing based method is performed to estimate the SI channel. Additional details about the compressed-sensing based method for estimating the SI channel are provided below. At block 306, the transceiver begins full duplex operation. The SI channel obtained during the training period is used to reduce the SI at the RF cancellation stage. The output of the RF stage is the intended signal plus the residual SI. To further reduce the SI, the residual SI is needed. To fully exploit the received signal, a joint residual SI and intended channel estimation is disclosed. Thus, at block 308, the transceiver estimates the residual SI (as well as the intended channel), after which, the method 300 ends.

FIG. 4 is a flowchart illustrating an exemplary covariance matrix method 400 for estimating the residual SI. The method 400 begins at block 402 where the transceiver determines the covariance matrix of the input signal. The residual SI and the intended signals subspaces are estimated from the covariance matrix on the input signal. The subspace of the different signal can be obtained even when the intended data are unknown. At block 404, the transceiver determines the ambiguity matrix for the residual SI channel using the known transmit SI signal. At block 406, the transceiver determines the ambiguity matrix for the intended channel using some pilot data. At block 408, the transceiver estimates the residual SI according to the ambiguity matrix for the residual SI channel and the ambiguity matrix for the intended channel, after which, the method 400 ends.

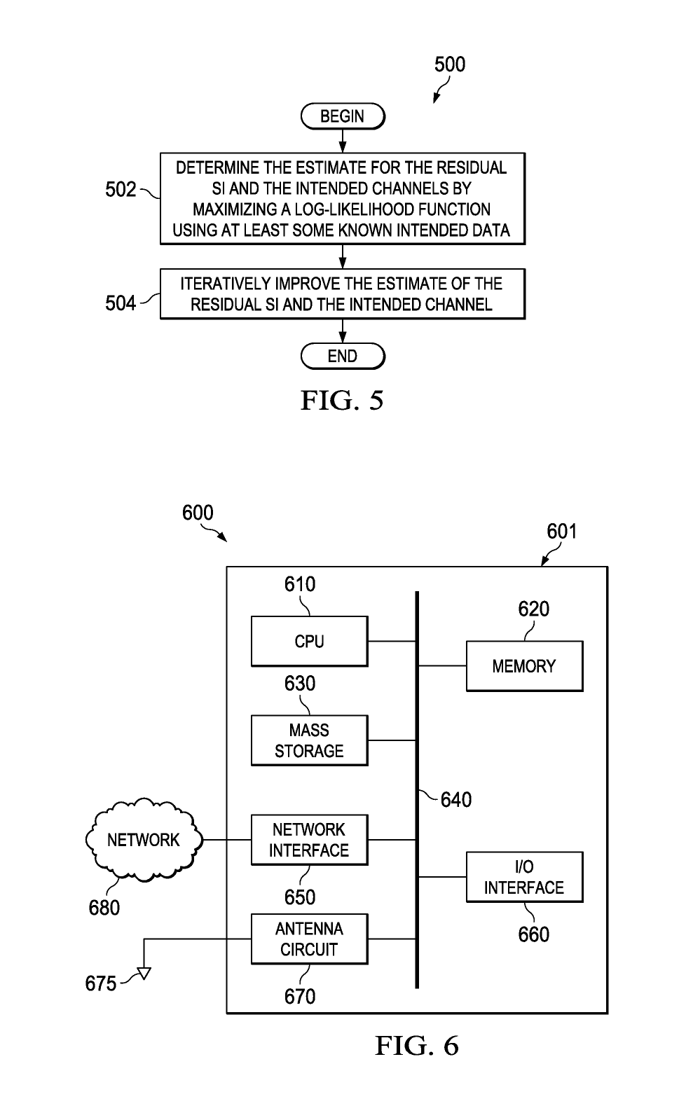

FIG. 5 is a flowchart illustrating an exemplary maximum likelihood criteria method 500 for estimating the residual SI. The method 500 begins at block 502 where the transceiver determines the estimate for the residual SI and the intended channels by maximizing a log-likelihood function using at least some known intended data. At block 504, the estimate of the residual SI and the intended channel are improved by an iterative procedure described in more detail below, after which, the method 500 ends.

Additional details of the disclosed SI estimation and residual SI estimation processes are discussed below.

Returning to FIG. 2, consider a MIMO point-to-point transceiver operating in a full-duplex fashion by simultaneously transmitting and receiving in the same frequency band. In addition to the intended signal, each transceiver receives its own self-interference that needs to be cancelled before demodulation. The radio-frequency (RF) cancellation stage is done prior to the LNA/ADC to avoid saturation/overlapping. The baseband cancellation stage is performed after the LNA/ADC to reduce the residual self-interference. In the following, we assume that a first estimate of the self-interference channel is available to create the cancelling signal in the RF cancellation stage and we take the received signal at the output of the RF cancellation. We suppose that each node is equipped with Nₜ transmitting antennas and Nᵣ receiving antennas. For an OFDM transmitted signal, the t^{th} received block, after removing the cyclic prefix, at antenna r is:

$${y}_{r , t} ( n ) = {\sum }_{q = 1}^{{N}_{t}} {\sum }_{l = 0}^{L} {h}_{r , q}^{( i )} ( l ) {x}_{q , t} ( n - l ) + {h}_{r , q}^{( s )} ( l ) {s}_{q , t} ( n - l ) + {w}_{r , t} ( n ) , \qquad ( 1 )$$

for n=0; : : : ; N−1, where x_{q,t}(n) and s_{q,t}(n), n=−N_{cp}, . . . , N−1, are the self-interference (from the same transceiver) and intended (from the other intended transceiver) OFDM signals, h_{r,q}⁽ⁱ⁾(l), l=0, . . . , L is the L-tap impulse response of the residual self-interference channel from antenna q to antenna r of the same transceiver after the RF cancellation stage, i.e., the difference between the actual self-interference channel and its estimate in the RF cancellation stage. h_{r,q}^{(s)}(l), l=0, . . . , L is the L-tap impulse response of the intended channel from antenna q to antenna r of the two different transceivers. N is the number of subcarriers and N_{cp} is the length of the cyclic prefix. Note that L≦N_{cp} to avoid intersymbol interference and the channels are zero-padded for channel order lower than L.

In the following, we suppose that P sub-carriers are dedicated to transmit pilot symbols. Let K={p₁, . . . , pₚ} be the index set of the sub-carrier reserved for pilots. The transmit signal s_{q,t}(n) can be represented as the sum of the following two signals:

$${s}_{q , t}^{p} ( n ) = {\sum }_{i = 1}^{P} {S}_{q , t} ( {p}_{i} ) {e}^{j 2 π {p}_{i} n / N} , \\ {s}_{q , t}^{d} ( n ) = {\sum }_{k ∉ K}^{ } {S}_{q , t} ( k ) {e}^{j 2 π {p}_{i} n / N} , \qquad ( 2 )$$

for n=0, . . . , N−1 where the first sequence s_{q,t}^{p}(n) contains the pilot symbols S_{q,t}(pᵢ), pᵢ∈K, and the second sequence s_{q,t}^{d}(n) contains the unknown transmit data symbols S_{q,t}(k), k∉K, during the t^{th} OFDM block. Using equation (2), the received signal in equation (1) becomes:

$${y}_{r , t} ( n ) = {\sum }_{q = 1}^{{N}_{t}} {\sum }_{l = 0}^{L} {h}_{r , q}^{( i )} ( l ) {x}_{q , t} ( n - l ) + {h}_{r , q}^{( s )} ( l ) {s}_{q , t}^{p} ( n - l ) + {h}_{r , q}^{( s )} ( l ) {s}_{q , t}^{( d )} ( n - l ) + {w}_{r , t} ( n ) . \qquad ( 3 )$$

For a more compact representation of equation (3), we define the set of N×(L+1) circulant matrices X_{q,cir,t}, for q=1, . . . , Nₜ which first row is [x_{q,t}(0), x_{q,t}(N−1), x_{q,t}(n−2), . . . , x_{q,t}(N−L)] and first column is [x_{q,t}(0), x_{q,t}(1), . . . , x_{q,t}(N−1)] and the N×Nₜ(L+1) matrix Xₜ=[X_{1,cir,t},X_{2,cir,t}, . . . , X_{N}_{ₜ}_{,cir,t}]. The matrix Sₜ^{p} is defined in the same way as Xₜ using the sequence {s_{q,t}^{p}(n)} instead of {x_{q,t}(n)}. We also gather the channel coefficients from all the transmitting antennas to the r^{th} receiving antenna as:

hᵣ⁽ⁱ⁾=[h_{r,1}⁽ⁱ⁾(0), . . . , h_{r,1}⁽ⁱ⁾(L), . . . , h_{r,N}_{ₜ}⁽ⁱ⁾(0), . . . , h_{r,N}_{ₜ}⁽ⁱ⁾(L)]^{T},

hᵣ^{(s)}=[h_{r,1}^{(s)}(0), . . . , h_{r,1}^{(s)}(L), . . . , h_{r,N}_{ₜ}^{(s)}(0), . . . , h_{r,N}_{ₜ}^{(s)}(L)]^{T},

Hᵣ^{(s)}=[H_{r,1}^{(s)}, H_{r,2}^{(s)}, . . . , H_{r,N}_{ₜ}^{(s)}], (4)

where the N×N block circulant matrix H_{r,q}^{(s)} defined as:

$${H}_{r , q}^{( s )} = ( \begin{matrix}{H}_{r , q}^{( s )} ( 0 ) & 0 & … & 0 & & {H}_{r , q}^{( s )} ( L ) & … & {H}_{r , q}^{( s )} ( 1 ) \\ {H}_{r , 1}^{( s )} ( 1 ) & ⋱ & & & & & ⋱ & ⋮ \\ ⋮ & & & & & & & {H}_{r , q}^{( s )} ( L ) \\ {H}_{r , q}^{( s )} ( L ) & … & {H}_{r , q}^{( s )} ( 0 ) & & & & & 0 \\ ⋮ & ⋱ & & & ⋱ & & & ⋮ \\ 0 & & {H}_{r , q}^{( s )} ( L ) & & … & & & {H}_{r , q}^{( s )} ( 0 )\end{matrix} ) .$$

Using the previous notations, the received signal at antenna r can be reformulated in a vector form as:

y_{r,t}=Xₜhᵣ⁽ⁱ⁾+Sₜ^{p}hᵣ^{(s)}+Hᵣ^{(s)}sₜ^{d}+w_{r,t}, (5)

Where y_{r,t}=[y_{r,t}(0), . . . , y_{r,t}(N−1]^{T} is the received N×1 vector after removing the cyclic prefix. By collecting the received vectors from the Nᵣ receiving antennas, we can express equation (5) as:

yₜ=(I_{N}_{ᵣ} [symbol] Xₜ)h⁽ⁱ⁾+(I_{N}_{ᵣ} [symbol] sₜ^{p})h^{(s)}+H^{(s)}sₜ^{d}+wₜ, (6)

where [symbol] refers to the Kronecker product between two matrices, I_{N}_{ᵣ} is the Nᵣ×Nᵣ identity matrix and

h⁽ⁱ⁾=[h₁⁽ⁱ⁾^{^{T}}, h₂⁽ⁱ⁾^{^{T}}, . . . , h_{N}_{ᵣ}⁽ⁱ⁾^{^{T}}]^{T},

h^{(s)}=[h₁^{(s)}^{^{T}}, h₂^{(s)}^{^{T}}, . . . , h_{N}_{ᵣ}^{(s)}^{^{T}}]^{T},

h^{(s)}=[h₁^{(s)}^{^{T}}, . . . , H_{N}_{ᵣ}^{(s)}^{^{T}}]^{T}. (7)

It has been observed that in many embodiments, the noise and the transmitted signals are independent or may be treated as independent. Therefore, in the following, we assume that the noise and the transmitted signals are independent, and the signal and noise variances are α² and σ², respectively.

To reduce the self-interference in equation (6), we need to estimate the residual self-interference channel h⁽ⁱ⁾ from yₜ. Since the self-signal Xₜ is known, the straightforward way to estimate the corresponding channel is to resort to a linear estimator using the matrix Xₜ. However, this strategy gives poor performance since the intended signal is treated as noise. As an alternative, disclosed herein is a joint estimation of the self-interference and intended channels, exploiting both the known pilot symbols and the statistic of the unknown part of the received signal. The use of the known and unknown transmit data in the estimation process is commonly referred as semi-blind channel estimation. To that end, we introduce h=[h⁽ⁱ⁾^{^{T}}, h^{(s)}^{^{T}}]^{T} as the vector to be estimated and Dₜ=[I_{N}_{ᵣ} [symbol] Xₜ, I_{N}_{ᵣ} [symbol] Sₜ^{p}] as the matrix gathering the symbols sent by the same transceiver and the known pilot symbols sent by the other intended transceiver. For a Gaussian received data, yₜ is a Gaussian random vector with mean Dₜh and covariance matrix R=α²H^{(s)}H^{(s)}^{^{H}}+σ²I_{NN}_{ᵣ}. It should be noted that the Gaussian assumption is well justified for an OFDM transmit signal. A total of T OFDM symbols are used in the estimation process. Following the Gaussian model, the log-likelihood function is given by:

$$ℒ ( {h}^{( i )} , {h}^{( s )} ) = - T log \vert R \vert - {\sum }_{t = 1}^{T} {( {y}_{t} - {D}_{t} h )}^{H} {R}^{- 1} ( {y}_{t} - {D}_{t} h ) , \qquad ( 8 )$$

where |:| returns the determinant of a matrix. The ML estimates of h⁽ⁱ⁾ and h^{(s)} are obtained by maximizing the log-likelihood function [symbol] (.,.). Noting that the covariance matrix R depends on the unknown vector h^{(s)}, maximizing the cost function with respect to h^{(s)} appears to be computationally intractable since it involves a NₜNᵣ(L+1)-dimensional grid search. To overcome this complexity, we ignore the relation between R and h^{(s)} and maximize the log-likelihood function with respect to h=[h⁽ⁱ⁾^{^{T}}, h⁽ⁱ⁾^{^{T}}]^{T} and R. This separability is exploited to solve the problem in a low-complexity manner. In the following, a closed-form solution and an iterative method to estimate the channels is disclosed.

A. Closed Form Solution

When assuming separable variables h and R, the conditional approach to maximize the log-likelihood function can be used. In the conditional approach, the covariance matrix is modeled as deterministic and unknown. Therefore, the matrix R is substituted by the solution R_{ML}(h) that maximizes (8) for a fixed h. Hence, maximizing equation (8) with respect to R leads to:

$${R}_{ML} ( h ) = \frac{1}{T} {\sum }_{t = 1}^{T} ( {y}_{t} - {D}_{t} h ) {( {y}_{t} - {D}_{t} h )}^{H} . \qquad ( 9 )$$

Substituting R by R_{ML}(h) in equation (8), we get the so-called compressed likelihood function:

$${ℒ}_{c} ( h ) = - T log \vert \frac{1}{T} {\sum }_{t = 1}^{T} ( {y}_{t} - {D}_{t} h ) {( {y}_{t} - {D}_{t} h )}^{H} \vert - T trace ( {I}_{{NN}_{r}} ) . \qquad ( 10 )$$

It follows that the ML channel estimate is given by:

$${h}_{ML} = arg {max}_{h} {ℒ}_{c} ( h ) . \qquad ( 11 )$$

In order to find a closed-form solution of equation (11), we first give the least square estimate of the channel:

$${h}_{LS} = {( {\sum }_{t = 1}^{T} {D}_{t}^{H} {D}_{t} )}^{- 1} {\sum }_{t = 1}^{T} {D}_{t}^{H} {y}_{t} . \qquad ( 12 )$$

Then, we define dₜ=Yₜ−Dₜh_{LS} and \tilde{R}=1/T Σₜ₌₁^{T}dₜdₜ^{H}. Following theses notations, the compressed likelihood function in equation (10) can be rephrased as:

$${ℒ}_{c} ( h ) = - T log \vert \begin{matrix}\tilde{R} + \frac{1}{T} {\sum }_{t = 1}^{T} {D}_{t} ( h - {h}_{LS} ) {( h - {h}_{LS} )}^{H} {D}_{t}^{H} - \\ {D}_{t} ( h - {h}_{LS} ) {d}_{t}^{H} - {{d}_{t} ( h - {h}_{LS} )}^{H} {D}_{t}^{H}\end{matrix} \vert , \qquad ( 13 )$$

where the constant terms irrelevant to the maximization have been discarded. Let define ξ=h−h_{LS}. As the block number T increases, the LS estimate h_{LS} approaches the ML estimate h_{ML}. Therefore, the difference ξ_{ML}=h_{ML}−h_{LS} between the two estimates becomes small. Using the fact that for any matrix M satisfying ∥M∥<<1, where ∥M∥ denotes the Frobenius norm of the matrix M, we have |I+M|≈1+trace (M) |I+M|≈1+trace (M), the log-likelihood function in equation (13) is rearranged to obtain:

$${ℒ}_{c} ( h ) = - T log \vert \tilde{R} \vert - T ( 1 + \frac{1}{T} trace ( {\tilde{R}}^{- 1} {\sum }_{t = 1}^{T} {D}_{t} {ξξ}^{H} {D}_{t}^{H} - {D}_{t} ξ {d}_{t}^{H} - {d}_{t} {ξ}^{H} {D}_{t}^{H} ) ) , \qquad ( 14 )$$

where we substitute h−h_{LS} by ξ. Since the log-function is an increasing function, the maximization of [symbol] _{c} (h) is equivalent to:

$${ξ}_{ML} = arg {max}_{ξ} {\sum }_{t = 1}^{T} {ξ}^{H} {D}_{t}^{H} {\tilde{R}}^{- 1} {D}_{t} ξ - {d}_{t}^{H} {\tilde{R}}^{- 1} {D}_{t} ξ - {ξ}^{H} {D}_{t}^{H} {\tilde{R}}^{- 1} {d}_{t} . \qquad ( 15 )$$

By setting the first derivative with respect to ξ to zero, the solution to equation (15) is given by:

$${ξ}_{ML} = {( {\sum }_{t = 1}^{T} {D}_{t}^{H} {\tilde{R}}^{- 1} {D}_{t} )}^{- 1} {\sum }_{t = 1}^{T} {D}_{t}^{H} {\tilde{R}}^{- 1} {d}_{t} . \qquad ( 16 )$$

Using dₜ=yₜ−Dₜh_{LS} and h_{ML}=h_{LS}+ξ_{ML}, the ML channel estimate is given by:

$${h}_{ML} = {( {\sum }_{t = 1}^{T} {D}_{t}^{H} {\tilde{R}}^{- 1} {D}_{t} )}^{- 1} {\sum }_{t = 1}^{T} {D}_{t}^{H} {\tilde{R}}^{- 1} {y}_{t} . \qquad ( 17 )$$

The ML estimate is different from the LS estimate because of the weighting matrix \tilde{R}⁻¹. Actually, the ML and LS estimates are equivalent in the presence of white Gaussian noise. In our case, the effective noise is composed from the thermal noise and the unknown transmit signal, which is not a white noise.

B. Iterative ML Estimator

The closed-form solution in equation (17) depends on \tilde{R}, which is an estimate of the covariance matrix R. Therefore, a better estimate of R results in a better estimate of the channel vector h. On the other hand, the matrix R depends on the unknown intended channel coefficients h^{(s)} that we want to estimate. Exploiting again the reparability of the log-likelihood function in h and R, a common approach in this situation is to resort to an iterative procedure. If the channel vector is given, the covariance matrix R that maximizes the log-likelihood function for that given h is:

$${R}_{ML} ( h ) = \frac{1}{T} {\sum }_{t = 1}^{T} ( {y}_{t} - {D}_{t} h ) {( {y}_{t} - {D}_{t} h )}^{H} . \qquad ( 18 )$$

And conversely, consider that R is available, the solution to the problem arg maxₕ [symbol] (h, R) can be computed as:

$${h}_{ML} ( R ) = {( {\sum }_{t = 1}^{T} {D}_{t}^{H} {R}^{- 1} {D}_{t} )}^{- 1} {\sum }_{t = 1}^{T} {D}_{t}^{H} {R}^{- 1} {y}_{t} . \qquad ( 19 )$$

The disclosed approach iterates between equation (18) and equation (19). At the i^{th} iteration, the estimate Rᵢ₋₁ obtained at iteration i−1 is used to find h as hᵢ=h_{ML}(Rᵢ₋₁). Then, the estimate of R is updated at iteration i as Rᵢ=R_{ML}(hᵢ). The procedure is stopped when there is no significant difference between two consecutive estimates. In an embodiment, like many iterative procedures, initialization is a critical issue for convergence. In our case, setting R₀=I appears to be a reasonable starting point. At the first iteration, we obtain the LS estimate given in equation (12). As we iterate, the matrix Rᵢ acts as a weighting matrix to improve the estimated channel.

The proof of convergence to the global maximum of the log-likelihood function may not straightforward because the function at hand is not verified to be convex. However, using the closed-form expression obtained in the previous section, it is possible to simply prove the convergence to the ML solution. In fact, when initializing the procedure with R₀=I, the iterative procedure returns, in the second iteration, the same channel estimate given in the closed-form solution in equation (17). That is, after two iterations, the procedure operates close to the ML solution. Thus, we have:

$$\begin{matrix}ℒ ( {h}_{i} , {R}_{i} ) = {max}_{R} ℒ ( {h}_{i} , R ) \\ \geq ℒ ( {h}_{i} , {R}_{i - 1} ) \\ = {max}_{h} ℒ ( h , {R}_{i - 1} ) \\ \geq ℒ ( {h}_{i - 1} , {R}_{i - 1} ) .\end{matrix} \qquad ( 20 )$$

Therefore, the log-likelihood function is increased after each iteration, and for a good initialization, the convergence to the global maximum is rapid. In an embodiment, when initializing the procedure with R₀=I, the iterative procedure converges to the ML solution after a reasonable number of iterations.

FIG. 6 is a block diagram of a processing system 600 that may be used for implementing the devices and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 600 may comprise a processing unit 601 equipped with one or more input/output devices, such as a speaker, microphone, mouse, touchscreen, keypad, keyboard, printer, display, and the like. The processing unit 601 may include a central processing unit (CPU) 610, memory 620, a mass storage device 630, a network interface 650, an I/O interface 660, and an antenna circuit 670 connected to a bus 640. The processing unit 601 also includes an antenna element 675 connected to the antenna circuit.

The bus 640 may be one or more of any type of several bus architectures including a memory bus or memory controller, a peripheral bus, video bus, or the like. The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs.

The mass storage device 630 may comprise any type of storage device configured to store data, programs, and other information and to make the data, programs, and other information accessible via the bus 640. The mass storage device 630 may comprise, for example, one or more of a solid state drive, hard disk drive, a magnetic disk drive, an optical disk drive, or the like.

The I/O interface 660 may provide interfaces to couple external input and output devices to the processing unit 601. The I/O interface 660 may include a video adapter. Examples of input and output devices may include a display coupled to the video adapter and a mouse/keyboard/printer coupled to the I/O interface. Other devices may be coupled to the processing unit 601 and additional or fewer interface cards may be utilized. For example, a serial interface such as Universal Serial Bus (USB) (not shown) may be used to provide an interface for a printer.

The antenna circuit 670 and antenna element 675 may allow the processing unit 601 to communicate with remote units via a network. In an embodiment, the antenna circuit 670 and antenna element 675 provide access to a wireless wide area network (WAN) and/or to a cellular network, such as Long Term Evolution (LTE), Code Division Multiple Access (CDMA), Wideband CDMA (WCDMA), and Global System for Mobile Communications (GSM) networks. Additional, in some embodiments, the antenna circuit 670 operates in Full Duplex (FD) mode. In some embodiments, the antenna circuit 670 and antenna element 675 may also provide Bluetooth and/or WiFi connection to other devices. In an embodiment, the antenna circuit 670 includes a transmitted signal cancellation system.

The processing unit 601 may also include one or more network interfaces 650, which may comprise wired links, such as an Ethernet cable or the like, and/or wireless links to access nodes or different networks. The network interface 601 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

### APPENDIX: STOCHASTIC CRB

The CRB is defined as the inverse of the Fisher Information Matrix (FIM). The real FIM can be formulated as:

$$\begin{matrix} {J}_{R} ( h ) = 2 ( \begin{matrix}ℜ ( {J}_{hh} ) & - ( {J}_{hh} ) \\ ( {J}_{hh} ) & ℜ ( {J}_{hh} )\end{matrix} ) + 2 ( \begin{matrix}ℜ ( {J}_{{hh}^{*}} ) & - ( {J}_{{hh}^{*}} ) \\ ( {J}_{{hh}^{*}} ) & ℜ ( {J}_{{hh}^{*}} )\end{matrix} ) , \\ where & ( 21 ) \\ {J}_{hh} ( i , j ) = ( {\sum }_{t = 1}^{T} {D}_{t}^{H} {R}^{- 1} {D}_{t} ) ( i , j ) + trace ( {R}^{- 1} \frac{\partial R}{\partial {h}^{*} ( i )} {R}^{- 1} \frac{\partial R}{\partial {h}^{*} ( j )} ) \\ {J}_{{hh}^{*}} ( i , j ) = trace ( {R}^{- 1} \frac{\partial R}{\partial {h}^{*} ( i )} {R}^{- 1} \frac{\partial R}{\partial {h}^{*} ( j )} ) . & ( 22 )\end{matrix}$$

The first derivative of R with respect to h*(i) is:

$$\frac{\partial R}{\partial {h}^{*} ( i )} = \{ \begin{matrix}0 , & for i = 1 , … , {N}_{t} {N}_{r} ( L + 1 ) \\ {α}^{2} {H}^{( s )} \frac{\partial {H}^{( s )}}{\partial {h}^{*} ( i )} , & otherwise .\end{matrix} \qquad ( 23 )$$

The expression of the CRB depends on the specific realization of the channel. Therefore, we average the obtained CRB over a set of independent realizations of the channel coefficients. Note that in equation (23), we keep the dependence of the covariance matrix R on h^{(s)}.

The following references are incorporated herein by reference:
[1] J. I. Choi, M. Jain, K. Srinivasan, P. Levis, and S. Katti, “Achieving single channel, full duplex wireless communication,” in Proc. ACM MobiCom, New York, N.Y., USA, 2010, pp. 1-12.
[2] M. Duarte and A. Sabharwal, “Full-duplex wireless communications using off-the-shelf radios: Feasibility and first results,” in Proc. ASILOMAR Signals, Syst., Comput., 2010, pp. 1558-1562.
[3] M. Duarte, A. Sabharwal, V. Aggarwal, R. Jana, K. Ramakrishnan, C. Rice, and N. Shankaranarayanan, “Design and characterization of a full-duplex multiantenna system for WiFi networks,” IEEE Trans. Vehicular Technology, vol. 63, no. 3, pp. 1160-1177, March 2014.
[4] D. Kim, H. Ju, S. Park, and D. Hong, “Effects of channel estimation error on full-duplex two-way networks,” IEEE Trans. Vehicular Technology, vol. 62, no. 9, p. 4667, 2013.
[5] M. Duarte, C. Dick, and A. Sabharwal, “Experiment-driven characterization of full-duplex wireless systems,” IEEE Trans. Wireless Comm., vol. 11, no. 12, pp. 4296-4307, 2012.
[6] S. Li and R. D. Murch, “Full-duplex wireless communication using transmitter output based echo cancellation,” in Proc. IEEE Global Telecommun. Conf., 2011, pp. 1-5.
[7] E. De Carvalho and D. T. Slock, “Cramer-rao bounds for semi-blind, blind and training sequence based channel estimation,” in 1^{st} IEEE Workshop Signal Processing Advances Wireless Communications (SPAWC), 1997, pp. 129-132.
[8] F. Wan, W.-P. Zhu, and M. Swamy, “A semiblind channel estimation approach for mimo-OFDM systems,” IEEE Trans. Signal Process., vol. 56, no. 7, pp. 2821-2834, 2008.
[9] H. Ochiai and H. Imai, “Performance analysis of deliberately clipped OFDM signals,” IEEE Trans. Comm., vol. 50, no. 1, pp. 89-101, 2002.
[10] L. L. Scharf, Statistical signal processing. Addison-Wesley Reading, 1991, vol. 98.
[11] P. Stoica and A. Nehorai, “Performance study of conditional and unconditional direction-of-arrival estimation,” IEEE Trans. Acoust., Speech and Signal Process., vol. 38, no. 10, pp. 1783-1795, 1990.
[12] U. Mengali and A. N. D'Andrea, Synchronization techniques for digital receivers. Springer, 1997.
[13] S. M. Kay, Fundamentals of statistical signal processing, Volume 1: Estimation theory. Prentice Hall, 1993.
[14] S. Talwar, M. Viberg, and A. Paulraj, “Blind separation of synchronous co-channel digital signals using an antenna array. Part I: Algorithms,” IEEE Trans. Signal Process., vol. 44, no. 5, pp. 1184-1197, 1996.
Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for reducing self-interference (SI) in a full duplex transmission system, the method comprising:
estimating a radio frequency (RF) SI signal according to a sampled received signal and a transmitted signal during a half-duplex operation;
obtaining a corrected signal, wherein the corrected signal is a difference signal between an analog received signal and the estimated RF SI signal, and the corrected signal comprises an intended signal plus a residual SI signal;
estimating the residual SI signal in a baseband during full duplex operation; and
obtaining an intended signal, wherein the intended signal is a difference signal between the corrected signal in a digital domain and the estimated residual SI signal.

2. The method of claim 1, wherein estimating the RF SI signal comprises executing a compressed-sensing-based procedure.

3. The method of claim 1, wherein estimating the residual SI comprises jointly estimating the residual SI and intended signal.

4. The method of claim 1, wherein estimating the residual SI comprises maximizing a log-likelihood function.

5. The method of claim 4, further comprising iteratively improving an accuracy of the estimated residual SI.

6. The method of claim 1, wherein estimating the RF SI signal comprises executing a compressed-sensing-based procedure.

7. The method of claim 1, wherein at least one pilot symbol is used to estimate an intended channel and wherein the sampled received signal contains a mix of known and unknown signals.

8. A wireless network component configured for full duplex operation, comprising:
a radio frequency (RF) self-interference (SI) cancellation stage component configured to estimate a RF SI signal according to a sampled received signal and a transmitted signal during a half-duplex operation, wherein the RF SI cancellation stage component is further configured to determine a corrected signal, wherein the corrected signal is a difference signal between an analog received signal and the estimated RF SI signal, and the corrected signal comprises an intended signal plus a residual SI signal; and
a baseband SI cancellation stage component configured to estimate the residual SI in a baseband during full duplex operation, wherein the baseband SI cancellation stage component is further configured to determine an intended signal, wherein the intended signal is a difference signal between the corrected signal in a digital domain and the estimated residual SI signal.

9. The wireless network component of claim 8, wherein RF SI cancellation stage component is further configured to execute a compressed-sensing-based procedure.

10. The wireless network component of claim 8, wherein the baseband SI cancellation stage component is further configured to jointly estimate the residual SI and intended signal.

11. The wireless network component of claim 8, wherein the baseband SI cancellation stage component is further configured to maximize a log-likelihood function.

12. The wireless network component of claim 11, wherein the baseband SI cancellation stage component is further configured to iteratively improve an accuracy of the estimated residual SI.

13. The wireless network component of claim 8, wherein at least one pilot symbol is used to estimate the residual SI signal and wherein the sampled received signal contains a mix of known and unknown signals.

14. A system for reducing self-interference in a full duplex transmission system, comprising:
a processor; and
a computer readable storage medium storing programming for execution by the processor, the programming including instructions to:
estimate a radio frequency (RF) self-interference (SI) according to a sampled received signal and a transmitted signal during a half-duplex operation;
determine a corrected signal, wherein the corrected signal is a difference signal between an analog received signal and the estimated RF SI signal;
estimate a residual SI in a baseband during full duplex operation; and
determine an intended signal, wherein the intended signal is a difference signal between the corrected signal in a digital domain and the estimated residual SI signal.

15. The system of claim 14, wherein the programming further comprises instructions to execute a compressed-sensing-based procedure.

16. The system of claim 14, wherein the programming further comprises instructions to jointly estimate the residual SI and intended signal.

17. The system of claim 14, wherein the programming further comprises instructions to maximize a log-likelihood function.

18. The system of claim 17, wherein the programming further comprises instructions to iteratively improve an accuracy of the estimated residual SI.
